(19) United States
(12) Patent Application Publication
(10) Pub. No.: US 2007/0119138 A1
(43) Pub. Date: May 31, 2007

(54) Collecting assembly for grass cutting

(76) Inventors: Jeffrey Quentin Burcham, Mt. Airy, NC (US); Terry Mark Burcham, Galax, VA (US)

Correspondence Address: Charles Y. Lackey, PO Box 5871, Winston-Salem, NC, 27113-5871, US

(21) Appl. No.: 11/286,392

(22) Filed: Nov. 25, 2005

(51) Int. Cl. A01D 43/06

(52) U.S. Cl. 56/202

(57) ABSTRACT

This invention is an apparatus for a lawn mower having a rotating blade enclosed by a deck. A grass catching hopper is removably secured to the mower. A first conduit communicates with the deck or, in another embodiment, with a blower which induces increased airflow and moves grass clips and debris to the hopper interior. Controlled and enhanced air flow results from an air flow insert in the first conduit entrance. Air and entrained materials collide with a hopper interior wall, and a large amount of entrained materials drop to the hopper floor. Air and the small amount of entrained materials remaining in it are directed back toward the first wall and through an opening to a centrifugal chamber. Small openings in the chamber permit the passage of air flow and entrained materials into the hopper. Air and what remains of the entrained materials are then drawn out of the chamber and back to the intake of the blower through a second conduit.

### BACKGROUND OF THE INVENTION

1. Field of the Invention

The present invention relates to grass collection devices and, more particularly, to a collecting assembly for use in combination with a grass cutter or mower.

2. Description of the Prior Art

Previous lawn mowers have utilized a vacuum created by a rotating grass-cutting blade to collect grass clippings and other debris within a grass catcher, thus obviating the need to rake. The rotating blade will act as an impeller to force air and solid debris into a grass catcher. Generally, the grass catcher has rearwardly positioned vents or mesh which retain solids such as grass clippings, twigs and leaves within the grass catcher but allows the flow of air in which the solids are entrained to pass through the grass catcher.

A problem associated with this type system is that dust particles are capable of filtering through the mesh, thus creating a dust cloud behind the mower which is unpleasant for the operator of the mower and which may be harmful to the mower's engine. In addition, grass and debris can clog the mesh screens and thereby lower the catcher's efficiency and performance.

To alleviate this problem, a closed loop vacuum system was developed by Enters in which air and associated dust entering the grass catcher is returned to the mower blade through another chute, and thereby recirculated rather than being discharged into the atmosphere. However, the Enters system is complex and requires a multi-part grass catcher, including a rotating fan blade to increase the air flow generated by the mower blade from the solids sought to be deposited within the grass catcher. Mowers provided with such additional equipment were made wider and longer thus reducing to some extent the maneuverability of the assembly and its use on smaller yards or grassed areas. The additional equipment when added to existing mowers was affixed in a semi-permanent manner so that the mower had to be cut off during installation and removal thus making this a time consuming effort.

Thus, a need exists for a closed loop lawn mower vacuum system which automatically separates solids entrained in the air flow passing through the grass catcher in a highly efficient manner without discharging the debris and all of the air flow into the atmosphere. The system needed also requires carefully designed and fitted components that can be easily attached and removed and will not appreciably increase the width or length of the assembly when installed. It is to these needs that the present invention is directed.

### SUMMARY AND OBJECTIVES OF THE INVENTION

The present invention is a vacuum apparatus for a lawn mower that has a rotating blade and deck that encloses the blade. The vacuum apparatus includes a grass catcher or hopper that is removably secured to the mower. A first conduit communicates in some embodiments with a blower outside the deck which induces increased airflow and moves grass clips and debris to the hopper interior.

Smooth, controlled and enhanced air flow is attained by an air flow insert positioned in the first conduit entrance at the deck so that air and entrained clips, debris and dust are guided up the insert and into and across the hopper interior and collide with the opposite hopper interior wall. A centrifugal chamber is positioned in the hopper having an entry opening within the hopper and an outflow opening forming a hopper air flow outlet. A large amount of clips, debris and dust drops to the floor of the hopper when the entrained clips, debris and dust collide with the opposite interior wall, and the air is directed back toward the first wall and into the centrifugal chamber entry opening. Air flow and what remains of the dust, debris and dust passes through the chamber and on toward the hopper air flow outlet. The looped formed portion of the centrifugal chamber has a number of small openings strategically positioned along its outer perimeter wall which enable most of the remaining clips, debris and dust to pass centrifugally out of the air flow and into the hopper. The centrifugal treatment utilized in the present invention is a significant improvement in the present technology. The nearly clean air moving within the chamber passes out through the hopper air flow outlet and into the atmosphere. Alternatively, the nearly clean air can be directed back to the intake of the blower through a second conduit. Thus, in this embodiment, nearly clean air flow goes to the blower intake and not to the blade enclosing deck for recirculation.

The hopper is movably mounted on the mower so that the mower operator can empty it when full without getting off the mower. Emptying the hopper cleans the hopper interior. Alternatively, the mower can be equipped with plastic disposable bags mounted inside or outside the hopper if the terrain or circumstances make that use more acceptable. The second conduit can be uncoupled from the blower intake so that the air stream from the hopper can be utilized as a hand held blower. The first conduit can be removed, a deflector installed and the assembly used as a wide area blower. The blower can be started and stopped by an independent control not associated with the rotating motor blades.

Thus there has been outlined the more important features of the invention in order that the detailed description that follows may be better understood and in order that the present contribution to the art may be better appreciated. There are, of course, additional features of the invention that will be described hereinafter and which will form the subject matter of the claims appended hereto. In that respect, before explaining at least one embodiment of the invention in detail, it is to be understood that the invention is not limited in its arrangement of the components set forth in the following description and illustrated in the drawings. The invention is capable of other embodiments and of being practiced and carried out in various ways.

It is also to be understood that the phraseology and terminology employed herein are for the purpose of description and should not be regarded as limiting in any respect. Those skilled in the art will appreciate that the concept upon which this disclosure is based may readily be utilized as a basis for designing other structures, methods and systems for carrying out the several purposes of this development. It is important that the claims be regarded as including such equivalent methods and products resulting therefrom that do not depart from the spirit and scope of the present invention. The application is neither intended to define the invention of the application, which is measured by its claims, nor to limit its scope in any way.

Thus, the objectives of the invention set forth above, along with the various features of novelty which characterize the invention, are noted with particularity in the claims annexed to and forming a part of this disclosure. For a better understanding of the invention, its operating advantages and the specific results obtained by its use, reference should be made to the following detailed specification taken in conjunction with the accompanying drawings wherein like characters of reference designate like parts throughout the several views.

The drawings are included to provide a further understanding of the invention and are incorporated in and constitute a part of this specification. They illustrate embodiments of the invention and, together with their description, serve to explain the principles of the invention.

### BRIEF DESCRIPTION OF THE DRAWINGS

FIG. 1 is a side elevational perspective view of the collecting assembly of the present invention including a vacuum apparatus installed on a mower;

FIG. 2 is a rear elevational, cut away perspective view of the collecting assembly shown in FIG. 1 illustrating the placement of the loop formed chamber within the hopper;

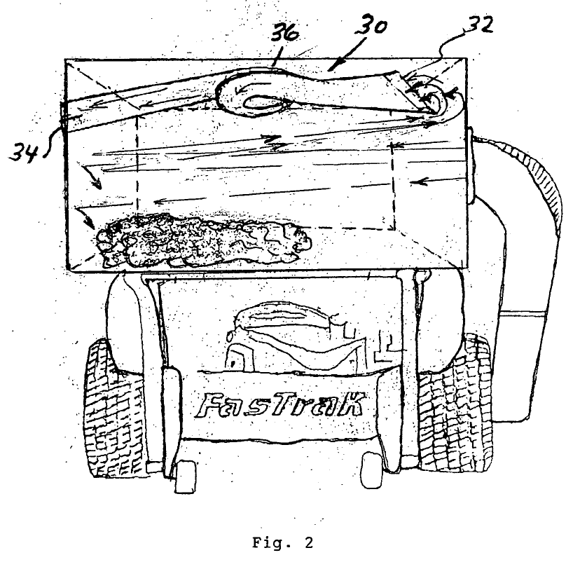

FIG. 3 is a perspective view of the first conduit showing the bottom of the conduit near its entrance being rolled clockwise so that the conduit bottom becomes the conduit side at the entrance to the hopper;

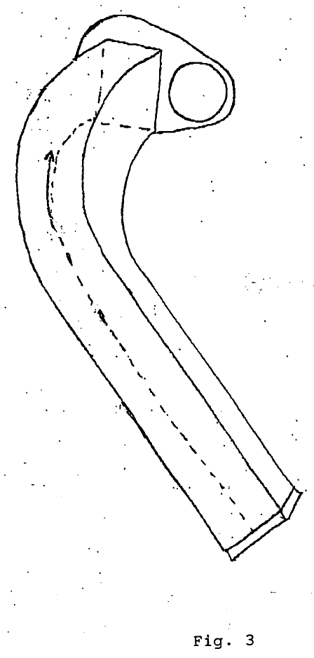

FIG. 4 is a perspective, sectional and schematic view of the first conduit with a conduit insert extending inside the first conduit and around the first bend to improve, control and enhance air flow up the first conduit and into the hopper;

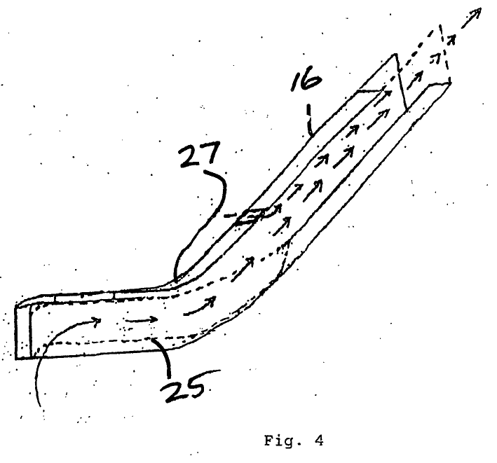

FIG. 5 is a perspective and fragmentary view of a direct to catcher or rear mounted blower arrangement for the present invention;

FIG. 6 is a schematic flow diagram showing the airflow and entrained clips, debris and dust moving from the first conduit, into and through the centrifugal chamber within the hopper with the clips, debris and dust moving out of the chamber and into the hopper through openings in the loop formed portion outer perimeter wall and the substantially clean remaining air flow passing through the air flow outlet into the outside atmosphere or back to the blower intake;

FIG. 7 is a schematic view of the loop formed chamber of the present invention being operably positioned adjacent and connected to a modified conventional mower by creating an opening in the hopper;

FIG. 8 is a perspective and fragmentary view of a utility dump box mounted on a riding mower;

FIG. 9 is a perspective and fragmentary view of the present invention wherein a blower has been connected directly to the mower deck;

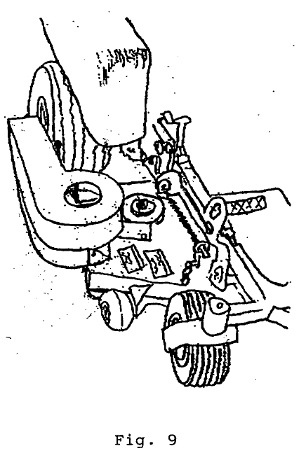

FIG. 10 is a side elevational and perspective view of the mower used with the collector apparatus which has been modified to convert the collection blower to a wide area blower; and

FIG. 11 is a side elevational and perspective view of the mower used with a T frame to move the hopper forward and closer to the rear axle and avoid the installation of a counterweight, reduce the overall length of the machine thereby increasing its maneuverability.

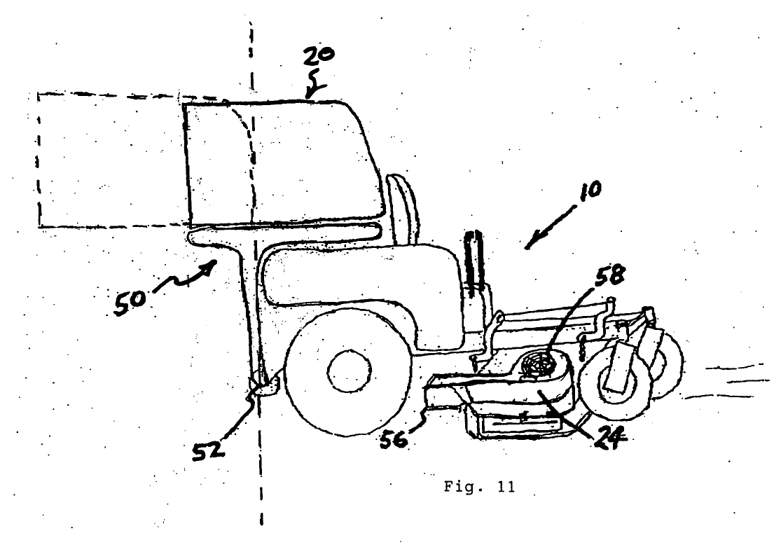

### DETAILED DESCRIPTION OF THE PREFERRED EMBODIMENT

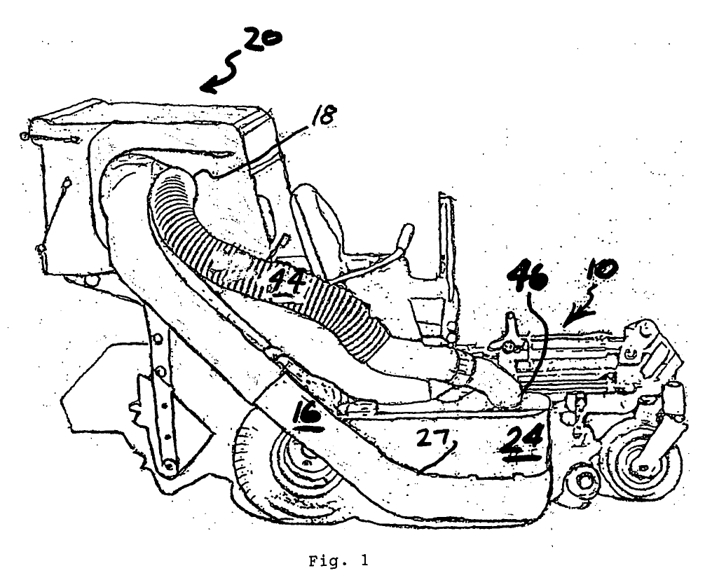

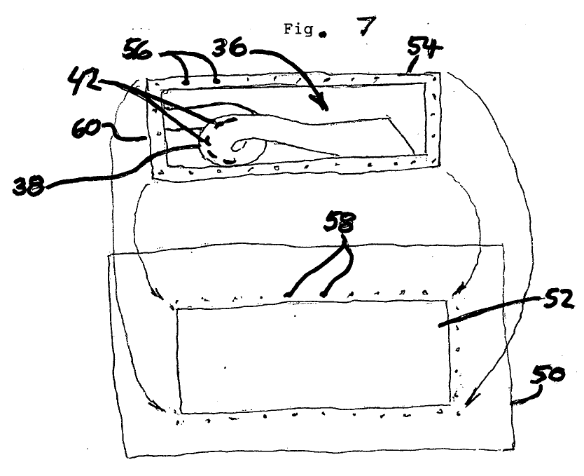

Referring now to the drawings and particularly to FIG. 1, a grass cutting machine such as a riding mower shown generally as 10 is equipped with a rotary cutting blade mounted on a shaft 12 positioned beneath mower 10 in a deck or housing 14 (FIG. 7) surrounding the blade. A first conduit 16 extends from housing 14 on to an opening 18 in a hopper 20. Because of the rotary movement of the blade, air currents are set up which cause entrainment of the produced grass clippings, debris and dust in the turbulent body of air created by rotation of the of the blade. This air flow may be used exclusively to operate the machine or it can be combined with air flow from a blower 24, which can be located anywhere along conduit 16. This induces greater air flow within conduit 16 which includes the moving clippings, debris and the like through first conduit 16 and into hopper 20 through opening 18.

Air flow is enhanced in conduit 16 by the use of a carefully designed conduit insert 25 placed inside first conduit 16 at its opening next to mower housing 14 and extending beyond the curved section 27 of first conduit 16. Insert 25 is shaped to guide air and entrained debris flow smoothly around and along the surfaces of first conduit 16 that would, without such an insert, be slower and less efficient.

Air and entrained clippings, dust and debris flow into and across hopper interior and collide with opposite wall 26. A large amount of the clippings and debris moving with the air flow are dislodged when they engage wall 26 and fall to the floor.

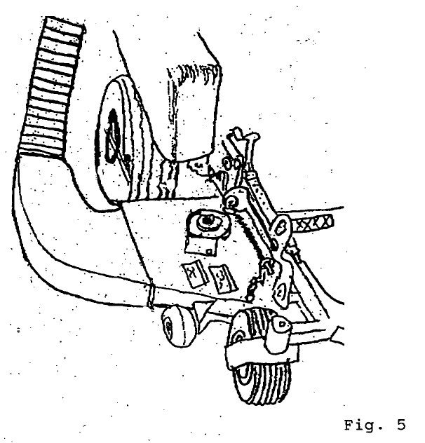

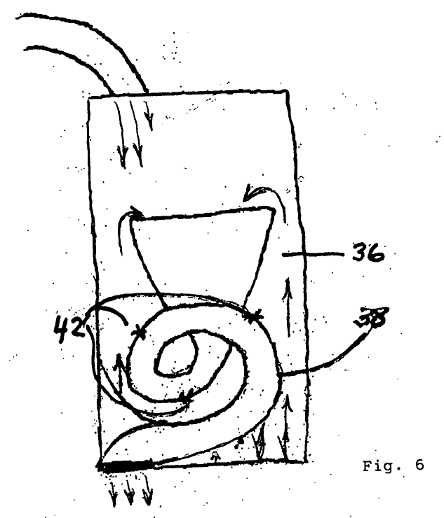

A centrifugal chamber shown generally as 30 is positioned in hopper 20 having an entry opening 32 and an outflow opening forming a hopper outflow outlet 34. The loop 36 of chamber 30 has an outer perimeter wall 38, an inner perimeter wall 40, and a number of relatively small openings 42 (FIGS. 6 and 7) formed in outer perimeter wall 38 as shown in FIG. 5. Chamber entry opening 32 is relatively large, and loop 36 has a substantially smaller opening 39. Air flow from opening 32 into smaller opening 39 of loop 36 results in an increase in air speed. Loop 36 acts as a centrifugal device pushing entrained clips, debris and dust toward outer perimeter wall 38, through openings 42 and into hopper 20. Air flowing out outflow outlet 34 is substantially free of clips, debris and dust.

The centrifugal chamber concept may be utilized with most mowers with conventional hoppers. In FIG. 7, a conventional hopper 50 has been provided with a new opening 52. The centrifugal chamber 36 of the present invention is partially encased in a closure member 54, and member 54 is provided with bolt holes 56 that align with matching holes 58 in hopper 50 surrounding opening 52 to secure closure member 54 to hopper 50. An outlet 60 can be provided anywhere on hopper 50 that is close to the hopper intake opening.

As an alternative embodiment of the present invention, the nearly clean air may be directed back to blower 24 through a second conduit 44 which extends to the intake 46 of blower 24 as shown in FIG. 1. The return air flow to intake 46 of blower 24 is relatively free from clippings, debris and dust since most of those materials were removed when the entrained materials passed from loop 36, spun out of the air flow stream and out through openings 42. The return air when entering the intake of blower 24 joins with the air flow pulling the newly formed clippings and debris out of the cutting area and into first conduit 16 to commence another cycle.

Several additional features of the present invention improve efficiency and operation and to overcome other troublesome features long associated with the riding mower industry. A small blower 24 has been used because it saves fuel and occupies a smaller space thus resulting in a smaller width of the entire system, adding only about 6 inches to the conventional mower width. It can be frame mounted or mounted on other machines if weight balancing is needed. It can also be provided with an on/off control which solves a long-standing tedious requirement of having to remove the mower drive belt to disengage the blower.

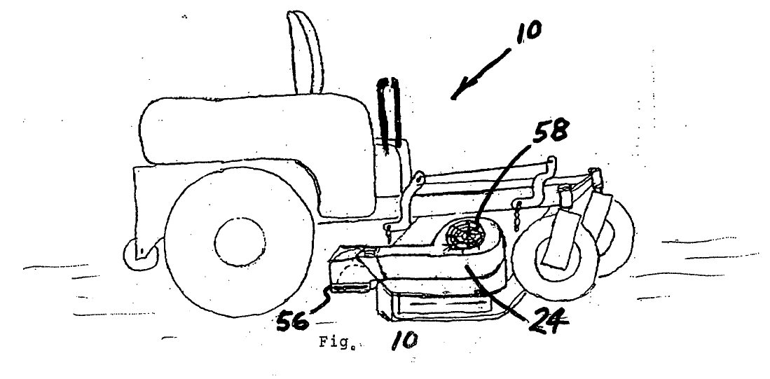

Blower 24 can also be used with mower 10 to function as a wide area blower by removing first conduit 16 and replacing it width a downwardly directed deflector 56 as shown in FIG. 10. First conduit 16 and hopper 20 have been removed in FIG. 10, however both components can be left in place while mower 10 and blower 24 operate to blow away surface debris by merely disconnecting blower 24 from first conduit 16. A guard grill 58 is installed over blower intake 46 to protect the operator and intake 46 from invasion by possibly damaging trash and debris.

Hopper 20 is mounted on mower 10 to hold the length of the entire system to an increase of only 8 inches. It is preferably made of metal or plastic to minimize ridges and other irregular surfaces to reduce air flow resistance. Hopper 20 can be equipped with fabric bags carried inside or be bypassed in favor of fabric bags mounted elsewhere on the mower for clippings and debris collection.

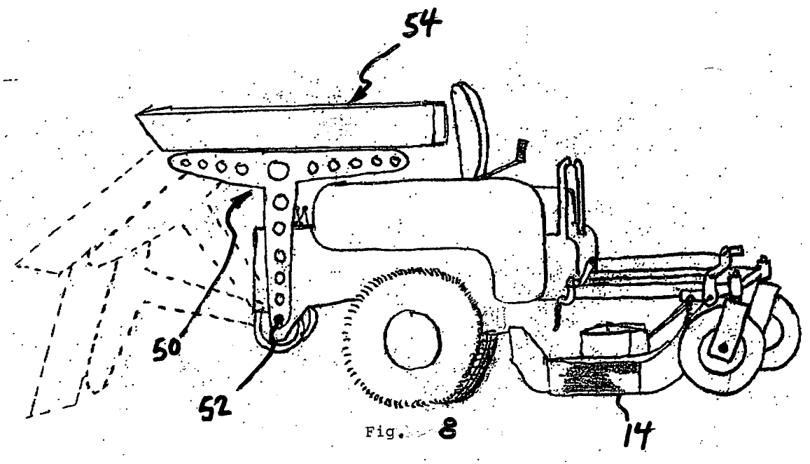

Hopper 20 can be mounted on a T-frame member shown generally as 50 (FIGS. 8, lo) which is pivotally connected to the rear lower end 52 of mower 10. T-frame member 50 can be tiltably controlled to dump hopper 20 rearwardly and near the ground so that dust and debris are kept away from the mower engine. The door of hopper 20 opens progressively as hopper 20 is dumping, it moving to the top of hopper 20 for ground clearance. The location of hopper 20 puts weight forward of mower 10 and permits the use of little or no counterweights on zero turn mowers. The hopper dump handle is in a convenient location for easy access, movement and operation. It is unnecessary to leave the seat when operating it for any reason.

As an alternative to hopper 20, a dump bed body box generally shown as 54 (FIG. 8) is comprised of a box constructed of steel, aluminum or plastic and is mounted on T-frame member 50 like hopper 20. Varying sizes may be used as situations dictate.

The parts of the collecting assembly are simple to attach and detach using only factory bolt holes and pin mount locations on the mower. Lightweight materials such as plastic and efficient fabrication methods keep the weight of the assembly at a minimum. All parts of the assembly fit into hopper 20 for storage. Blower 24 can be mounted to the deck or frame forward of the rear wheels for weight distribution.

It should be emphasized that the collector assembly of the present invention as generally described above can readily be mounted on most conventional type of riding mowers, walk behind mowers, push mowers or the like. In addition, the specific disposition of the various components comprising the collector assembly relative to the cutting machine itself is not a limiting or important portion of the present invention as long as proper air flow is established from the cutting area, moves into and through first conduit 16, and then into and through hopper 20, through centrifugal chamber 36 back to the intake of blower 24 or the atmosphere.

From the preceding description, it can be seen that a collecting assembly for use in combination with a cutting or mowing machine has been provided that will meet all of the advantages of prior art devices and offer additional advantages not heretofore available. With respect to the foregoing invention, the optimum relationship to the parts of the invention including variations in size, materials, shape, form, function and manner of operation, use and assembly are deemed readily apparent to those skilled in the art, and all equivalent relationships illustrated in the drawings and described in the specification are intended to be encompassed herein.

The foregoing is considered as illustrative only of the principles of the invention. Numerous modifications and changes will readily occur to those skilled in the art, and it is not desired to limit the invention to the exact construction and operation shown and described. All suitable modifications and equivalents that fall within the scope of the appended claims are deemed within the present inventive concept.

What is claimed is:

1. A grass collecting assembly for a lawn mower, the mower having a rotating: blade, a deck enclosing the blade, and an outlet port in the deck, the collecting assembly comprising: a first conduit having first and second ends, the conduit first end connecting with the deck outlet port and receiving air flow and entrained clips, debris and dust as the blade cuts and urges the cut grass, debris and dust out of the deck outlet port, into the first conduit first end and through the first conduit; a centrifugal chamber having an enclosure and an inlet port and an outlet port therein, the inlet port communicating with and receiving from the first conduit second end the air flow, entrained clips, debris and dust; and collecting means associated with the centrifugal chamber and having an exterior and an interior and input and output openings formed therein, the input opening receiving the first conduit second end and the air, entrained clips, debris and dust flowing therefrom, the output opening connecting with the centrifugal chamber inlet port; and the connected output opening and outlet port receiving the air flow and remaining entrained materials from the centrifugal chamber.

2. A collecting assembly as claimed in claim 1 further comprising a plurality of openings in the centrifugal chamber wall through which air flow and substantially all of the entrained debris and dust can pass into and be held within the collecting means interior.

3. A collecting assembly as claimed in claim 1 wherein the centrifugal chamber has outer periphery surfaces.

4. A collecting assembly as claimed in claim 1 further comprising: a second conduit having a first end and a second end, the second conduit first end connected to the joined centrifugal chamber outlet port and collecting means output opening and the second conduit second end connecting to the deck.

5. A collecting assembly as claimed in claim 2 wherein the centrifugal chamber has outer periphery surfaces.

6. A collecting assembly as claimed in claim 2 further comprising: a second conduit having a first end and a second end, the second conduit first end connected to the joined centrifugal chamber outlet port and collecting means output opening and the second conduit second end connecting to the deck.

7. The collecting assembly as claimed in claim 1 further comprising: a blower positioned adjacent the deck inducing additional air flow to move the grass clips, debris and dust through the first conduit and into the collecting means.

8. The collecting assembly as claimed in claim 7 further comprising: a plurality of openings in the centrifugal chamber wall through which air flow and substantially all of the entrained debris and dust can pass into and be held within the collecting means interior.

9. The assembly as claimed in claim 7 wherein the centrifugal chamber has outer periphery surfaces.

10. The assembly as claimed in claim 8 wherein the centrifugal chamber has outer periphery surfaces.

11. The assembly as claimed in claim 7 further comprising: a second conduit having a first end and a second end, the second conduit first end connected to the joined centrifugal chamber outlet port and collecting means output opening and the second conduit second end connecting to the deck.

12. The assembly as claimed in claim 11 wherein the centrifugal chamber has outer periphery surfaces.

13. The assembly as claimed in claim 1 wherein the collecting means is a hopper.

14. The assembly as claimed in claim 1 wherein the centrifugal chamber is a tubular, hollow member having a first diverging end, a middle looped section having a restricted diameter connected to the first diverging end and a second end formed with the collecting means output opening, the centrifugal chamber section and second end having a plurality of openings which permit air flow and entrained clippings and debris to move centrifugally from the interior of the tubular member into the collecting means.

15. The assembly as claimed in claim 14 further comprising: a blower positioned adjacent the deck inducing additional air flow to move the grass clips, debris and dust through the first conduit and into the collecting means; and a second conduit having a first end and a second end, the second conduit first end connected to the joined centrifugal outlet port and collecting means output opening, and the second conduit second end connecting to the deck.

16. The assembly as claimed in claim 15 wherein the collecting means is a hopper.

17. A method of collecting grass clippings, debris and dust caused by mowing grass with a lawn mower comprising the steps of: directing air flow, entrained clips, debris and dust from the mowing area into a collecting device; collecting a portion of the entrained clips, debris and dust in the collecting device; moving the air flow, remaining entrained clips, debris and dust into a centrifugal chamber having a closed loop formed portion with openings therein; directing the air flow, remaining entrained clips, debris and dust through the closed loop portion so that substantially all of the remaining entrained clips, debris and dust passes through the openings and back into the collecting device; and discharging the air flow, remaining clips, debris and dust out of the centrifugal chamber to the outside air.
